(19) United States
(12) Patent Application Publication
(10) Pub. No.: US 2016/0274404 A1
(43) Pub. Date: Sep. 22, 2016

(54) DISPLAY PANEL, DISPLAY DEVICE, AND METHOD FOR MANUFACTURING DISPLAY PANEL

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventor: Dong CHEN, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 14/409,394

(22) PCT Filed: Jun. 20, 2014
(86) PCT No.: PCT/CN2014/080390

§ 371 Date: Dec. 18, 2014

(30) Foreign Application Priority Data
Oct. 12, 2013 (CN) 201310478367.X

(51) Int. Cl. G02F 1/1345; G02F 1/1335; G02F 1/1339

(52) U.S. Cl. CPC G02F 1/13454; G02F 1/1339; G02F 1/13394; G02F 1/133514; G02F 1/13452; G02F 2001/13398

(57) ABSTRACT

The present disclosure provides a display panel, a display device and a method for manufacturing a display panel. The display panel includes a first substrate, a second substrate arranged opposite to the first substrate, a common conductive film arranged on the first substrate, and a jumper for supplying power to a gate driver IC and arranged on the second substrate, wherein a barrier layer for insulating the common conductive film from the jumper is formed at an entire or a part of a region of the common conductive film corresponding to a region where the jumper is located.

### CROSS-REFERENCE TO RELATED APPLICATION

The present application is the US national phase of PCT Application No. PCT/CN2014/080390 filed on Jun. 20, 2014, which claims a priority of the Chinese patent application No. 201310478367.X filed on Oct. 12, 2013, the disclosure of which is incorporated herein by reference in its entirety.

### TECHNICAL FIELD

The present disclosure relates to the field of liquid crystal display, in particular to a display panel, a display device, and a method for manufacturing a display panel.

### BACKGROUND

For a mobile product, there is an increasing demand on a narrow bezel of a display panel, and in order to meet this demand, integrated circuits (IC) cannot be placed at left and right sides of a color film substrate of the display panel. Currently, a GOA technology has been widely used in the display panel of a mobile phone or a flat-panel PC.

The GOA (Gate Driver on Array) technology refers to forming gate driver ICs directly on an array substrate, and a region where the gate driver ICs is located is called as a GOA region. Due to the use of this technology, it is able to reduce the steps desired for manufacturing the display panel, and reduce the production cost.

When the display panel is manufactured with the GOA technology, a gate insulator mask (GI mask) or a jumper made of indium tin oxide (ITO) may be used. Here, the present disclosure relates to the latter.

For a TN-type or VA-type display panel, a sealant containing metallic particles is coated and connected so as to form an electrical connection between a common electrode on the array substrate and a common conductive film (Com ITO) on a color film of the color film substrate. However, if the sealant is inadvertently applied to regions at both sides of the color film substrate corresponding to the GOA region, the jumper made of ITO at the GOA region will likely be electrically connected to the common conductive film on the color film, and as a result, the GOA region cannot operate normally.

In order to overcome this drawback, when the jumper made of ITO, rather than the GI mask, is used for manufacturing the existing TN-type or VA-type display panel with the GOA technology, the sealant is applied at a position away from a jumper region of the GOA region. As a result, a bezel width of the display panel will be increased by about 0.5 mm, and it is impossible for the mobile product to meet the requirement on the narrow bezel of the display panel.

### SUMMARY

An object of the present disclosure is to provide a display panel manufactured with a GOA technology and having a narrow bezel, a display device and a method for manufacturing a display panel.

In one aspect, the present disclosure provides a display panel, including a first substrate, a second substrate arranged opposite to the first substrate, a common conductive film arranged on the first substrate, and a jumper for supplying power to a gate driver IC and arranged on the second substrate, wherein a barrier layer for insulating the common conductive film from the jumper is formed at an entire or a part of a region of the common conductive film corresponding to a region where the jumper is located.

Alternatively, the first substrate is a color film substrate, the second substrate is an array substrate, and the barrier layer is arranged outside the common conductive film on the first substrate.

Alternatively, the common conductive film is provided with a sealant application region onto which a sealant containing conductive particles is applied, an overlapping portion is provided between the sealant application region and the region of the common conductive film corresponding to the region where the jumper is located, and the barrier layer at least covers the overlapping portion.

Alternatively, the barrier layer merely covers the overlapping portion.

Alternatively, the barrier layer is made of a negative or positive photoresist.

Alternatively, the barrier layer has a thickness of less than 2 μm.

Alternatively, the barrier layer has a thickness of 1 μm.

Alternatively, a spacer for supporting is arranged between the first substrate and the second substrate, and the barrier layer and the spacer are made of an identical material and arranged on an identical layer.

Alternatively, the spacer is of a columnar shape.

In another aspect, the present disclosure provides a display device including the above-mentioned display panel.

In yet another aspect, the present disclosure provides a method for manufacturing a display panel, including the steps of: providing a common conductive film on a first substrate, providing a jumper for supplying power to a gate driver IC on a second substrate, and forming a barrier layer for insulating the common conductive film from the jumper at an entire of a part of a region of the common conductive film corresponding to a region where the jumper is located.

Alternatively, the first substrate is a color film substrate, the second substrate is an array substrate, and the barrier layer is arranged outside the common conductive film on the first substrate.

Alternatively, the common conductive film is provided with a sealant application region onto which a sealant containing conductive particles is applied, an overlapping portion is provided between the sealant application region and the region of the common conductive film corresponding to the region where the jumper is located, and the barrier layer at least covers the overlapping portion.

Alternatively, the barrier layer has a thickness of less than 2 μm.

Alternatively, the method further includes forming a spacer for supporting between the first substrate and the second substrate while forming the barrier layer, and the spacer is made of an identical material and arranged on an identical layer to the barrier layer.

Alternatively, the method further includes applying a negative photoresist layer onto the common conductive film, exposing regions of the negative photoresist layer where the barrier layer and the columnar spacer are to be formed, and removing an unexposed region of the negative photoresist layer so as to form the barrier layer and the columnar spacer.

Alternatively, when the region of the negative photoresist layer where the barrier layer is to be formed is exposed, the region of the negative photoresist layer where the barrier layer is to be formed has a light transmission rate of less than 5%.

Alternatively, the common conductive film is provided with a sealant application region onto which a sealant is applied, an overlapping portion is provided between the sealant application region and a region of the common conductive film corresponding to the region where the jumper is located, and the method further comprises exposing a region of the negative photoresist layer corresponding to the overlapping portion and a region of the negative photoresist layer where the columnar spacer is to be formed.

Alternatively, the method further includes the steps of: providing the common conductive film on the color film substrate and providing the jumper for supplying power to the gate driver IC on the array substrate; applying a positive photoresist layer onto the common conductive film; exposing the positive photoresist layer after sheltering a region of the positive photoresist layer corresponding to the region where the jumper is located and a region of the positive photoresist layer where the columnar spacer is to be formed; and removing the exposed region of the positive photoresist layer so as to form the barrier layer for insulating the common conductive film from the jumper and the columnar spacer for supporting the color film substrate and the array substrate.

According to the display panel and the display device of the present disclosure, the barrier layer is arranged between the common conductive film and the region where the jumper is located. As a result, it is unnecessary to apply the sealant at a position away from the region where the GOA jumper is located, and it is able to reduce a bezel width of the display panel by about 0.5 mm, thereby to meet the requirement on a narrow bezel of the display panel.

According to the method for manufacturing the display panel of the present disclosure, it is able to manufacture a TN-type display panel with a narrow bezel merely by four masking processes, without any additional masking process, and to reduce the bezel width of the display panel by about 0.5 mm, thereby to meet the requirement on a narrow bezel of the display panel.

### BRIEF DESCRIPTION OF THE DRAWINGS

FIG. 1 is a front view of a display panel according to one embodiment of the present disclosure;

FIG. 2 is a partially-enlarged, sectional view of the display panel according to one embodiment of the present disclosure;

FIGS. 3(a), 3(b) and 3(c) are schematic views showing a method for manufacturing a display panel according to one embodiment of the present disclosure; and

FIGS. 4(a) and 4(b) are schematic views showing the method for manufacturing the display panel according to another embodiment of the present disclosure.

### DETAILED DESCRIPTION

The present disclosure will be described hereinafter in conjunction with the drawings. The following drawings are for illustrative purposes only, but shall not be used to define any shape or scale.

According to a display panel of the present disclosure, a barrier layer is arranged between a common conductive film and a region where a jumper is located, and it is unnecessary to apply a sealant at a position away from a jumper region of a GOA region. As a result, it is able to reduce a bezel width of the display panel by about 0.5 mm, thereby to advantageously meet the requirement on a narrow bezel of the display panel for a mobile product.

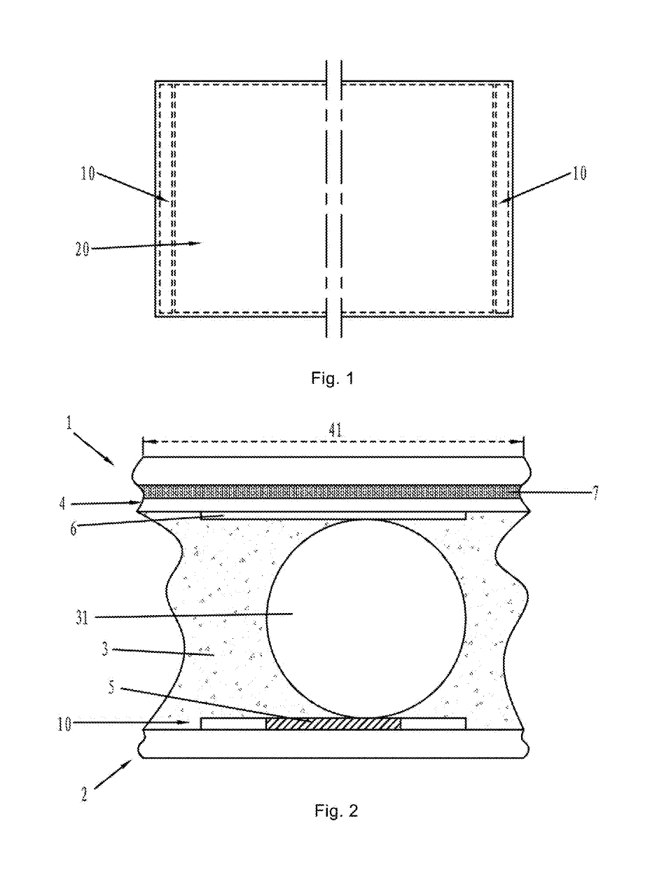

FIG. 1 is a front view showing a display panel according to one embodiment of the present disclosure, in which a middle region surrounded by a dotted line represents a work area 20 including an active area, and regions at both sides represent jumper regions 10. In the prior art, a sealant is required to avoid the jumper regions 10.

FIG. 2 is a partially-enlarged, sectional view showing the display panel, in which the jumper region 10 is included. The display panel includes a first substrate 1, a second substrate 2 arranged opposite to the first substrate 1, and a sealant 3 containing conductive particles 31 and arranged between the first substrate 1 and the second substrate 2.

The first substrate 1 is provided with a common conductive film 4, and the second substrate 2 is provided with a jumper 5 for supplying power to a gate driver IC. The jumper 5 is alternatively made of ITO, and a region where the jumper 5 is located is called as the jumper region 10 of the GOA region (the jumper region 10 for short). An insulating barrier layer 6 is arranged at a position of the common conductive film 4 corresponding to the region where the jumper 5 is located (i.e., the jumper region 10). Alternatively, the insulating barrier layer 6 is arranged at a position on a surface of the common conductive film 4 corresponding to the region where the jumper 5 is located (i.e., the jumper region 10), so as to achieve a good insulating effort.

In the above embodiment, the first substrate 1 may be a color film substrate, the second substrate 2 may be an array substrate, and the barrier layer 6 is arranged at an outer surface of the common conductive film 4 on the first substrate 1.

To be specific, the outermost side of the common conductive film 4 on the first substrate 1 has a preset sealant application region 41 onto which a sealant is to be applied, and an overlapping portion is provided between the sealant application region 41 and the region of the common conductive film 4 corresponding to the region where the jumper 5 is located. The barrier layer 6 is alternatively arranged outside the overlapping portion, i.e., the barrier layer 6 alternatively covers at least the overlapping portion. As shown in FIG. 2, the sealant application region 41 fully covers a region corresponding to the region where the jumper 5 is located, and at this time, the overlapping portion is just the region of the common conductive film 4 corresponding to the region where the jumper 5 is located. In some cases, the sealant application region 41 may partially overlap the region corresponding to the region where the jumper 5 is located, and at this time an identical effect may be achieved as long as the barrier layer is arranged on the overlapping portion.

Because the insulating barrier layer 6 is arranged at the region of the common conductive film 4 corresponding to the region where the jumper 5 is located, there will be no electrical connection between the jumper 5 and the common conductive film 4 due to the barrier layer 6, even if the conductive particles 31 in the sealant 3 are located between the jumper 5 and the common conductive film 4, just as shown in FIG. 2. Hence, it is able to ensure normal operation of the GOA region. In this regard, it is unnecessary to apply the sealant at a position away from the GOA region, like that in the prior art. As a result, it is able to reduce the bezel width of the display panel by about 0.5 mm, thereby to meet the requirement on a narrow bezel of the display panel for the mobile product in a better manner.

In the display panel according to the present disclosure, a black matrix 7 as well as red, green and blue film may be provided on the first substrate 1 serving as the color film substrate. In other words, the color film substrate may be a conventional one, and will not be particularly defined herein.

In the display panel according to one embodiment of the present disclosure, the barrier layer 6 may be made of a negative or positive photoresist.

In the display panel according to one embodiment of the present disclosure, the barrier layer 6 has a thickness of less than 2 μm, e.g., about 1 μm.

The present disclosure further provides a display device including the above-mentioned display panel. The display device may be any product or member having a display function, such as a liquid crystal panel, an electronic paper, an OLED panel, a liquid crystal TV, a liquid crystal display, a digital photo frame, a mobile phone and a flat-panel PC.

The present disclosure further provides a method for manufacturing a display panel with four masking processes.

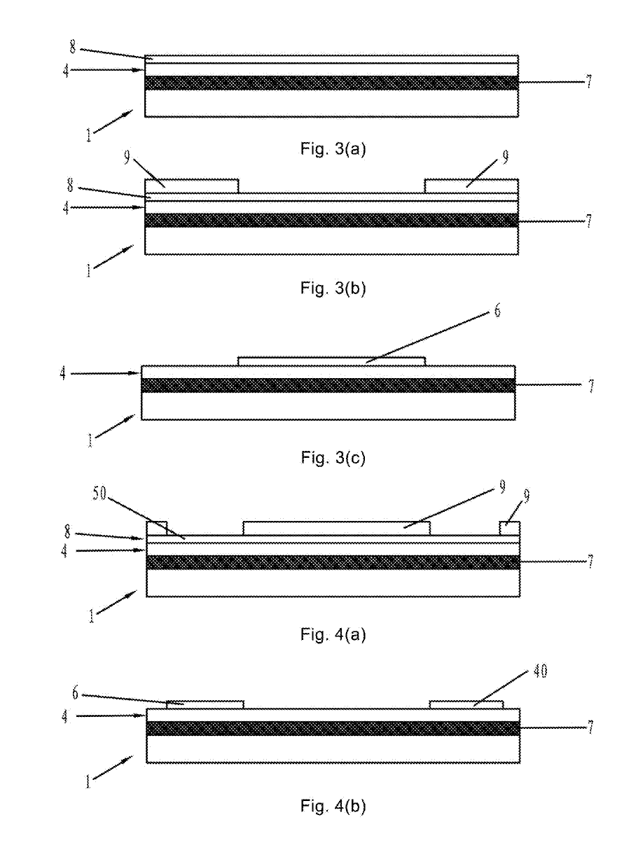

As shown in FIGS. 3(a), 3(b) and 3(c), the method includes the following steps.

At first, the color film substrate 1 is formed in a way similar to that for manufacturing a conventional color film substrate. For example, some necessary layers 7 as the black matrix and the red, green and blue film (not shown) may be formed on a base plate so as to form the color film substrate 1.

Then, the common conductive film 4 is arranged on the color film substrate 1 in a conventional way and at a position identical to that known in the conventional way. As shown in FIG. 3(a), the common conductive film 4 is just arranged on the color film substrate 1, for example by the conventional way.

Next, a negative photoresist layer 8 is applied onto the common conductive film 4. A negative photoresist, after being exposed to light, becomes an insoluable substance, and the negative photoresist is applied so as to form the negative photoresist layer 8.

Through the above steps, an intermediate member as shown in FIG. 3(a) will be obtained.

Then, a mask 9 is arranged at a region beyond the predetermined region where the barrier layer 6 is to be formed, so as to obtain an intermediate member as shown in FIG. 3(b).

A surface of the intermediate member as shown in FIG. 3(b) is exposed, and then the mask 9 and the negative photoresist layer 8 covered by the mask 9 are removed, so as to obtain the barrier layer 6 at the predetermined position as shown in FIG. 3(c). The resultant color film substrate 1 with the barrier layer 6 may be used in the display panel as shown in FIG. 2.

The array substrate may be manufactured prior to or subsequent to the formation of the color film substrate, or simultaneously. The method for manufacturing the array substrate may be identical to a conventional one, and it will not be particularly defined herein. In this embodiment, the jumper 5 for supplying power to the gate driver IC is provided at a predetermined position on the array substrate 2, and the region where the jumper is located is opposite to the position on the color film substrate 1 where the barrier layer 6 is formed. Finally, the sealant is applied onto the predetermined sealant application region, and the resultant color film substrate 1 and array substrate 2 are arranged opposite to each other to form a cell.

Alternatively, when the region of the negative photoresist layer 8 corresponding to the jumper region is exposed, the region has a light transmission rate of less than 5%. As a result, it is able to reduce the thickness of the barrier layer 6 as possible, thereby to ensure the thickness of the sealant as well as a wetted area thereof. Alternatively, the barrier layer 6 has a thickness of about 1 μm.

Alternatively, the common conductive film 4 is provided with the sealant application region 41 onto which the sealant is to be applied. If there is an overlapping portion between the sealant application region 41 and the region of the negative photoresist layer 8 corresponding to the jumper region 10, the overlapping portion may be exposed with the mask 9. In other words, the barrier layer 6 is merely formed at the overlapping portion, and it is unnecessary to form the barrier layer 6 at the entire region corresponding to the jumper region 10. As a result, it is able to reduce the area of the barrier layer.

Alternatively, as shown in FIGS. 4(a) and 4(b), a region where a columnar spacer is to be formed (e.g., a columnar spacer region 31) may be exposed while exposing a region 50 of the negative photoresist layer 9 corresponding to the jumper region 10 or the overlapping portion with the mask 9. As a result, it is able to simultaneously form the barrier layer 6 and the columnar spacer 40 for supporting the color film substrate 1 and the array substrate. An existing method for manufacturing a display panel already includes a step of forming the columnar spacer 40, so when forming the barrier layer 6 in this embodiment of the present disclosure, no additional step is required. In other words, the barrier layer 6 and the columnar spacer 40 with different functions may be formed in a single process, as long as the mask 9 is designed in accordance with the shapes and positions of the barrier layer 6 and the columnar spacer 40 to be formed. Such method is an improved method based on a conventional method. On one hand, a display panel with a narrower bezel is formed and on the other hand, cost and complexity for manufacturing the display panel is not increased as compared with the conventional method.

In the other embodiments of the present disclosure, the TN-type display panel with a narrow bezel may be manufactured with four masking processes using a positive photoresist rather than the negative photoresist. The method may include the following steps:

providing the common conductive film on the color film substrate, and providing the jumper for supplying power to the gate driver IC on the array substrate;

applying a positive photoresist layer onto the common conductive film;

exposing the positive photoresist layer after sheltering, with the mask, the region of the positive photoresist layer corresponding to the jumper region or, simultaneously, the region of the positive photoresist layer where the columnar spacer is to be formed; and

removing the exposed region of the positive photoresist layer, so as to form the barrier layer for insulating the common conductive film from the jumper or, simultaneously form the columnar spacer for supporting the color film substrate and the array substrate.

The above are merely the preferred embodiments of the present disclosure. It should be appreciated that, a person skilled in the art may make further improvements and modifications without departing from the principle of the present disclosure, and these improvements and modifications shall also fall within the scope of the present disclosure.

What is claimed is:

1. A display panel, comprising a first substrate, a second substrate arranged opposite to the first substrate, a common conductive film arranged on the first substrate, and a jumper for supplying power to a gate driver IC and arranged on the second substrate, wherein a barrier layer for insulating the common conductive film from the jumper is formed at an entire or a part of a region of the common conductive film corresponding to a region where the jumper is located.

2. The display panel according to claim 1, wherein the first substrate is a color film substrate, the second substrate is an array substrate, and the barrier layer is arranged outside the common conductive film on the first substrate.

3. The display panel according to claim 2, wherein the common conductive film is provided with a sealant application region onto which a sealant containing conductive particles is applied, an overlapping portion is provided between the sealant application region and the region of the common conductive film corresponding to the region where the jumper is located, and the barrier layer at least covers the overlapping portion.

4. The display panel according to claim 3, wherein the barrier layer merely covers the overlapping portion.

5. The display panel according to claim 1, wherein the barrier layer is made of a negative or positive photoresist.

6. The display panel according to claim 1, wherein the barrier layer has a thickness of less than 2 μm.

7. The display panel according to claim 6, wherein the barrier layer has a thickness of 1 μm.

8. The display panel according to claim 1, wherein a spacer for supporting is arranged between the first substrate and the second substrate, and the barrier layer and the spacer are made of an identical material and arranged on an identical layer.

9. The display panel according to claim 8, wherein the spacer is of a columnar shape.

10. A display device comprising the display panel according to claim 1.

11. A method for manufacturing a display panel, comprising the steps of:
providing a common conductive film on a first substrate, providing a jumper for supplying power to a gate driver IC on a second substrate; and
forming a barrier layer for insulating the common conductive film from the jumper at an entire of a part of a region of the common conductive film corresponding to a region where the jumper is located.

12. The method according to claim 11, wherein the first substrate is a color film substrate, the second substrate is an array substrate, and the barrier layer is arranged outside the common conductive film on the first substrate.

13. The method according to claim 11, wherein the common conductive film is provided with a sealant application region onto which a sealant containing conductive particles is applied, an overlapping portion is provided between the sealant application region and the region of the common conductive film corresponding to the region where the jumper is located, and the barrier layer at least covers the overlapping portion.

14. The method according to claim 11, wherein the barrier layer has a thickness of less than 2 μm.

15. The method according to claim 11, further comprising forming a spacer for supporting between the first substrate and the second substrate while forming the barrier layer, the spacer being made of an identical material and arranged on an identical layer to the barrier layer.

16. The method according to claim 15, further comprising:
applying a negative photoresist layer onto the common conductive film;
exposing regions of the negative photoresist layer where the barrier layer and the columnar spacer are to be formed; and
removing an unexposed region of the negative photoresist layer so as to form the barrier layer and the columnar spacer.

17. The method according to claim 16, wherein when the region of the negative photoresist layer where the barrier layer is to be formed is exposed, the region of the negative photoresist layer where the barrier layer is to be formed has a light transmission rate of less than 5%.

18. The method according to claim 17, wherein the common conductive film is provided with a sealant application region onto which a sealant is applied, an overlapping portion is provided between the sealant application region and a region of the common conductive film corresponding to the region where the jumper is located, and the method further comprises exposing a region of the negative photoresist layer corresponding to the overlapping portion and a region of the negative photoresist layer where the columnar spacer is to be formed.

19. The method according to claim 15, further comprising:
providing the common conductive film on the color film substrate and providing the jumper for supplying power to the gate driver IC on the array substrate;
applying a positive photoresist layer onto the common conductive film;
exposing the positive photoresist layer after sheltering a region of the positive photoresist layer corresponding to the region where the jumper is located and a region of the positive photoresist layer where the columnar spacer is to be formed; and
removing the exposed region of the positive photoresist layer so as to form the barrier layer for insulating the common conductive film from the jumper and the columnar spacer for supporting the color film substrate and the array substrate.
